(19) United States
(12) Patent Application Publication
(10) Pub. No.: US 2008/0277572 A1
(43) Pub. Date: Nov. 13, 2008

(54) Ionizing radiations

(76) Inventors: Fathi Djouider, Jeddah (SA); Mohammed Aljohani, Jeddah (SA)

Correspondence Address: Melvin I. Stoltz, 51 Cherry Street, Milford, CT, 06460, US

(21) Appl. No.: 12/069,701

(22) Filed: Feb. 11, 2008

(30) Foreign Application Priority Data
Feb. 13, 2007 (GB) 0702754.3

(51) Int. Cl. G01D 18/00; G01T 1/00

(52) U.S. Cl. 250/252.1; 250/395; 250/336.1

(57) ABSTRACT

An anthropometric phantom that can be subjected to ionizing radiations comprises a simulation of a part at least of a human body and which includes a number of cavities that contain a liquid that changes in colour when exposed to radiation.

### FIELD OF THE INVENTION

This invention relates to ionizing radiations.

Ionizing radiations are used, in particular, to cure cancer, i.e. by radiotherapy. The ionizing radiations have sufficient energy to break chemical bonds and separate electrons from their parent atoms and molecules in cancer cells, particularly in the nucleus containing DNA. The ultimate damage to the DNA leads to the death of the cancer cells.

However, gamma rays, alpha particles and beta particles used for medical purposes can be dangerous in that they can induce potential cancer when healthy cells around a cancer tumour are irradiated. In addition, X-rays which are used to medical imaging, for example, inspecting broken legs, can also induce potential cancer if a patient is over-exposed.

The absorbed dose of radiation is the amount of energy given to the medium, for example, a human exposed to radiation, per unit mass. It is normally measured in gray (Gy) defined as Joules/kg. Measurement of the absorbed dose due to radiation is the task of radiation dosimetry.

A number of different instruments have been used to measure the absorbed dose and are based on the detection of the physical or chemical changes caused by the radiation. For example, ionisation chambers measure the electrical charge produced by ionization of a gas inside a device called a detector. The measuring instruments typically provide an indirect determination of the dose.

Radiation dosimetry is needed in many areas, particularly in respect of cancer treatment using radiotherapy and in clinical diagnostic radiology.

As mentioned above, radiation therapy works by damaging the DNA of cancer cells causing them to die. Although normal cells are also sometimes damaged by the radiotherapy, healthy cells have the ability to repair themselves when subject to limited amounts of damage, while diseased cells are destroyed. External radiotherapy uses high energy rays (X-ray or gamma rays) or particle beams (protons or electrons) that are directed at the tumour to be treated, normally from several angles. Radiotherapy is normally given as a course of treatment spread over a number of days or weeks so as to allow the healthy cells around the tumour to recover from any damage that they may suffer.

It is, of course, important to ensure that the healthy cells are not subject to excessive damage and it is an object of the present invention to provide means for reducing the likelihood that such damage should occur.

### SUMMARY OF THE INVENTION

According to a first aspect of the present invention there is provided an anthropometric phantom that comprises a simulation of a part at least of a human body and which includes a number of cavities that contain a liquid that changes in colour when exposed to radiation.

The liquid in the cavities preferably comprises an aqueous solution of a chromate, which may be saturated with nitrous oxide. The aqueous solution may also contain a formate.

The main body of the phantom is preferably formed of polymethylmethacrylate, and may contain components formed of aluminium that simulate bones.

According to a second aspect of the present invention there is providing a method of assessing the doses of radiation resulting from the carrying out of a radiotherapy procedure that includes the use of an anthropometric phantom as defined above.

### BRIEF DESCRIPTION OF THE DRAWINGS

FIG. 1 is a schematic view of an anthropometric phantom,

FIG. 2 is a schematic horizontal sectional view of an adult abdomen,

FIG. 3 is a schematic horizontal sectional view of an adult head,

FIG. 4 is a schematic horizontal sectional view of an adult male chest,

FIG. 5 is a schematic horizontal sectional view of an adult female chest,

FIG. 6 is a schematic horizontal sectional view of an adult male pelvis, and

FIG. 7 is a schematic horizontal sectional view of an adult female pelvis.

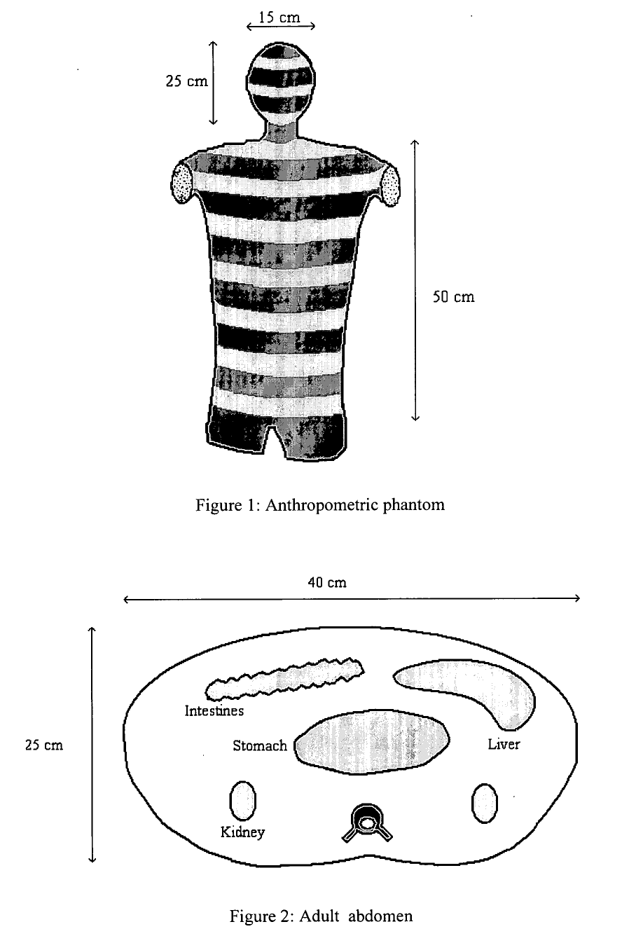

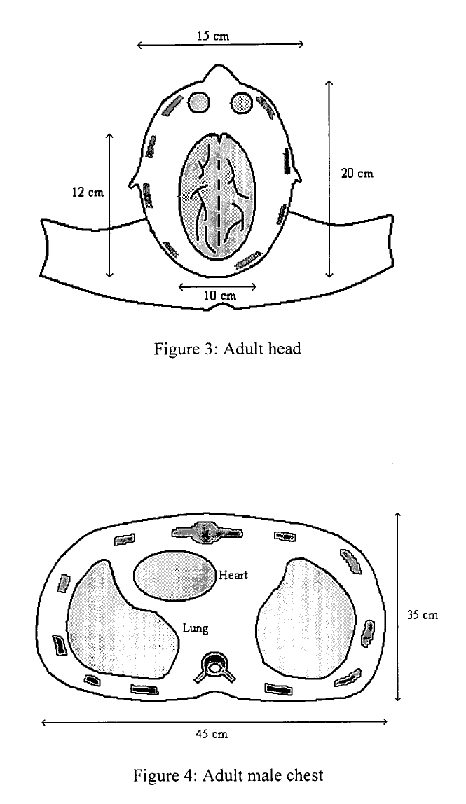

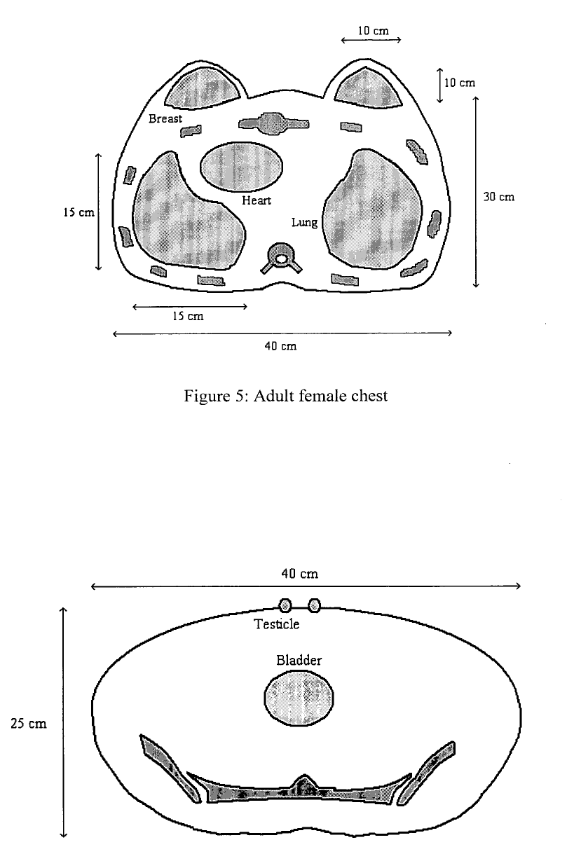

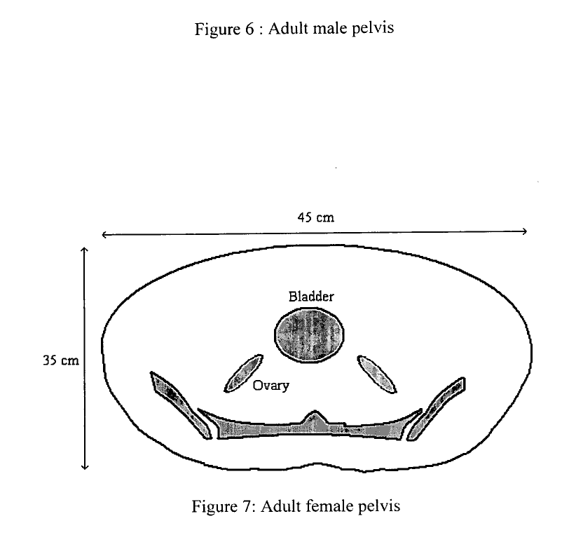

### DESCRIPTION OF THE PREFERRED EMBODIMENTS

The anthropometric phantom shown in the drawings is designed to provide a realistic representation of the human anatomical condition. It is produced from a material that has properties equivalent to those of human tissue, in terms of reaction to radiation. A suitable material is polymethylmethacrylate having a Specific Gravity of 1.19. As can be seen from the drawings, the phantom can simulate the head, neck, chest, abdomen and pelvic zone of a male or female. Components made of aluminium are contained within the structure made of polymethylmethacrylate and such components are designed to simulate different bones, for example, the cranium, spine and ribs.

Within the phantom there are cavities of different shapes and sizes designed to mimic selected body organs for in vivo dose measurements. For the particular phantoms shown in the drawings, the cavities that are provided represent the brain, eyes, thyroid gland, oesophagus, lungs, heart, stomach, liver, kidneys, rectum, bladder and gonads. If desired, the phantom model can be adjusted to match the sex and size of a particular patient. The cavities are filled with a chemical dosimeter solution and then, if desired, the chest, abdomen and pelvic zone of the phantom are covered with cloths to simulate clothing.

The completed anthropometric phantom is then placed on the treatment table of a radiotherapy machine and irradiated under the same protocol, i.e. the same dose for the same period of time, as a patient would be irradiated.

The chemical dosimeter solution with which the cavities are filled consists of a nitrous-oxide-saturated solution at pH 9.2 containing:—
a) 10⁻³ mol/dm of potassium chromate, and
b) 10⁻² mol/dm of sodium formate.

When this solution absorbs radiation energy, for example, gamma or X-rays, or a beam of electrons or protons, the chromate solutions changes from a yellow colour to a greenish blue colour. The amount of chromate ion conversion is directly proportional to the amount of energy absorbed, i.e. to the total dose of radiation. The bleaching or disappearance of the chromate ions is determined spectrophotometrically, the maximum absorption wavelength of this ion being 370 nm. The degree of bleaching increases linearly with doses from 0.1 kGy to at least 10 kGy and is independent of dose rate up to 70 kGy/min.

Once the change in optical density (CIOD) has been determined by the measurements obtained using the spectrophotometer, the dose of radiation that has been received in a particular cavity can be calculated using the formula:

Dose=1.04×10³×(CIOD).

It is thus possible to assess whether, for a planned radiation treatment programme, the dose of radiation received in any of the cavities is above prescribed guidelines. The possibility of subjecting a patient to excessive doses of radiation can thus be reduced.

The present invention thus provides benchmarks for the quality assurance and safety control of current radiotherapy procedures. Dose mapping of the head, thorax and abdomen of the phantom is very useful for obtaining an optimum dose delivery for a real patient.

1. An anthropometric phantom that comprises a simulation of a part at least of a human body and which includes a number of cavities that contain a liquid that changes in colour when exposed to radiation.

2. An anthropometric phantom as claimed in claim 1, in which the liquid in the cavities comprises an aqueous solution of a chromate.

3. An anthropometric phantom as claimed in claim 2, in which the aqueous solution is saturated with nitrous oxide.

4. An anthropometric phantom as claimed in claim 2, in which the aqueous solution also contains a formate.

5. An anthropometric phantom as claimed in claim 1, in which the main body of the phantom is formed of polymethylmethacrylate.

6. An anthropometric phantom as claimed in claim 5, which contains components formed of aluminium that simulate bones.

7. A method of assessing the doses of radiation resulting from the carrying out of a radiotherapy procedure that includes the use of an anthropometric phantom as claimed in claim 1.
